(19) United States
(12) Patent Application Publication
(10) Pub. No.: US 2008/0131031 A1
(43) Pub. Date: Jun. 5, 2008

(54) HANDHELD ELECTRONIC DEVICE WITH DIACRITICAL SELECTION AND TEXT DISAMBIGUATION

(76) Inventor: Sherryl Lee Lorraine Scott, Toronto (CA)

Correspondence Address: ECKERT SEAMANS CHERIN & MELLOTT, 600 GRANT STREET, 44TH FLOOR, PITTSBURGH, PA, 15219, US

(21) Appl. No.: 11/566,834

(22) Filed: Dec. 5, 2006

(51) Int. Cl. G06K 9/22

(52) U.S. Cl. 382/313

(57) ABSTRACT

A method and apparatus of enabling input on a handheld electronic device including the following steps: detecting as a first input a number of input member actuations comprising an actuation of an input member having assigned thereto both a non-diacritical version and a diacritical version; responsive to said detecting of the first input, displaying a linguistic element list for selection by a user comprising the non-diacritical version and at least one diacritical version; detecting as a second input a selection by the user of one linguistic element of the linguistic element list; and responsive to said detecting of the second input, displaying a variant list for selection by the user and comprising a number of variants, at least some of the variants each comprising the selected linguistic element of the second input.

### BACKGROUND

1. Technical Field

The disclosed and claimed concept relates generally to handheld electronic devices and, more particularly, to a method of enabling input on a handheld electronic device.

2. Background Information

Numerous types of handheld electronic devices are known. Examples of such handheld electronic devices include, for instance, personal data assistants (PDAs), handheld computers, two-way pagers, cellular telephones, and the like. Many handheld electronic devices also feature wireless communication capability, although many such handheld electronic devices are stand-alone devices that are functional without communication with other devices.

Such handheld electronic devices are generally intended to be portable, and thus are of a relatively compact configuration in which keys and other input structures often perform multiple functions under certain circumstances or may otherwise have multiple aspects or features assigned thereto. With advances in technology, handheld electronic devices are built to have progressively smaller form factors yet have progressively greater numbers of applications and features resident thereon. As a practical matter, the keys of a keypad can only be reduced to a certain small size before the keys become relatively unusable. In order to enable text entry, however, a keypad must be capable of entering all twenty-six letters of the Latin alphabet, for instance, as well as appropriate punctuation and other symbols.

One way of providing numerous letters in a small space has been to provide a “reduced keypad” in which multiple letters, symbols, and/or digits, and the like, are assigned to any given key. For example, a touch-tone telephone includes a reduced keypad by providing twelve keys, of which ten have digits thereon, and of these ten keys eight have Latin letters assigned thereto. For instance, one of the keys includes the digit “2” as well as the letters “A”, “B”, and “C”. Other known reduced keypads have included other arrangements of keys, letters, symbols, digits, and the like.

In order to enable a user to make use of the multiple letters, digits, and the like on any given key, numerous keystroke interpretation systems have been provided. For instance, a “multi-tap” system allows a user to substantially unambiguously specify a particular character on a key by pressing the same key a number of times equivalent to the position of the desired character on the key. For example, on the aforementioned telephone key that includes the letters “ABC”, and the user desires to specify the letter “C”, the user will press the key three times. While such multi-tap systems have been generally effective for their intended purposes, they nevertheless can require a relatively large number of key inputs compared with the number of characters that ultimately are output.

Another exemplary keystroke interpretation system would include key chording, of which various types exist. For instance, a particular character can be entered by pressing two keys in succession or by pressing and holding first key while pressing a second key. Still another exemplary keystroke interpretation system would be a “press-and-hold/press-and-release” interpretation function in which a given key provides a first result if the key is pressed and immediately released, and provides a second result if the key is pressed and held for a short period of time. While such systems have likewise been generally effective for their intended purposes, such systems also have their own unique drawbacks.

Another keystroke interpretation system that has been employed is a software-based text disambiguation function. In such a system, a user typically presses keys to which one or more characters have been assigned, actuating each key one time for each desired letter, and the disambiguation software attempts to predict the intended input. Numerous such systems have been proposed, and while many have been generally effective for their intended purposes, shortcomings still exist.

One such shortcoming arises when the handheld electronic device has a “keypad” in which various diacritical letters are associated with a given key in countries such as, for example, France, Germany and Italy. In the French language, the “é” and “è” diacritical letters may be associated with a single key that displays letters “E” and “R” and a numeral “1”. When such a key is depressed, the handheld electronic device will typically prefer displaying a non-diacritical letter “e” as the user's first input selection as opposed to the non-diacritical letter “r”. There are instances, however, as in the French language, when a user would prefer having a diacritical letter “é” or “è” appear as the first selection rather than the non-diacritical letter “e”.

It would be desirable, therefore, to provide an improved method of enabling input on a handheld electronic device in which the handheld electronic device has the capability of presenting to a user a diacritical letter most likely to be assigned by the user.

### BRIEF DESCRIPTION OF THE DRAWINGS

A full understanding can be gained from the following description when read in conjunction with the accompanying drawings in which:

FIG. 1 is a top plan view of an improved handheld electronic device showing a first linguistic element list and a first variant list in accordance with the disclosed and claimed concept;

FIG. 2 is a depiction of the display of FIG. 1 showing a second variant list in accordance with the disclosed and claimed concept;

FIG. 3 is a depiction of the display of FIG. 1 showing a second linguistic element list and a third variant list in accordance with the disclosed and claimed concept;

FIG. 4 is a schematic depiction of the improved handheld electronic device of FIG. 1;

FIG. 5 is a flowchart depicting an embodiment of a method in accordance with the disclosed and claimed concept; and

FIG. 6 is a top plan view of an alternative handheld electronic device in accordance with the disclosed and claimed concept.

### DESCRIPTION

When referring to the term “linguistic elements” and variations thereof, such designations shall refer broadly to any element that itself can be a language object or from which a language object can be constructed, identified, or otherwise obtained, and thus would include, but not be limited to, characters, letters, strokes, symbols, ideograms, phonemes, morphemes, digits (numbers), and the like.

When referring to the term “variants” and variations thereof, such designations shall refer broadly to words, prefixes, suffixes, other variants and the like.

When referring to the term “number” and variations thereof, such designation is meant to cover use of any numbers or digits including, but not limited, to the natural numbers as well as non-negative numbers.

When referring to the term “diacritical letters”, “diacritical versions”, and variations thereof, such designation is meant to cover use of accented characters, uppercase (Majuscule form) of such letters and other diacritical letters.

When referring to the term “reduced” and variations thereof in the context of a keypad, or other arrangement of input members, such designations shall refer broadly to an arrangement in which at least one of the input members has assigned thereto a plurality of linguistic elements such as, for example, characters in the set of Latin letters.

For purposes of the description hereinafter, the terms “upper”, “lower”, “right”, “left”, “vertical”, “horizontal”, “top”, “bottom”, and derivatives thereof shall relate to the disclosed and claimed concept as it is oriented in the FIGS.

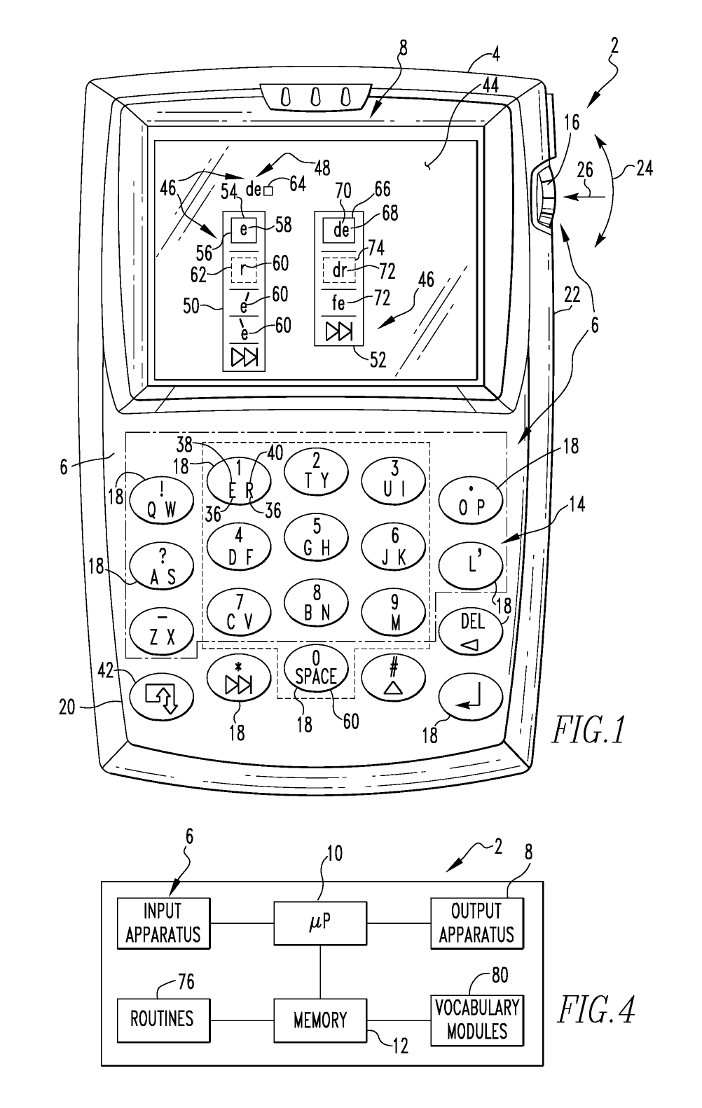

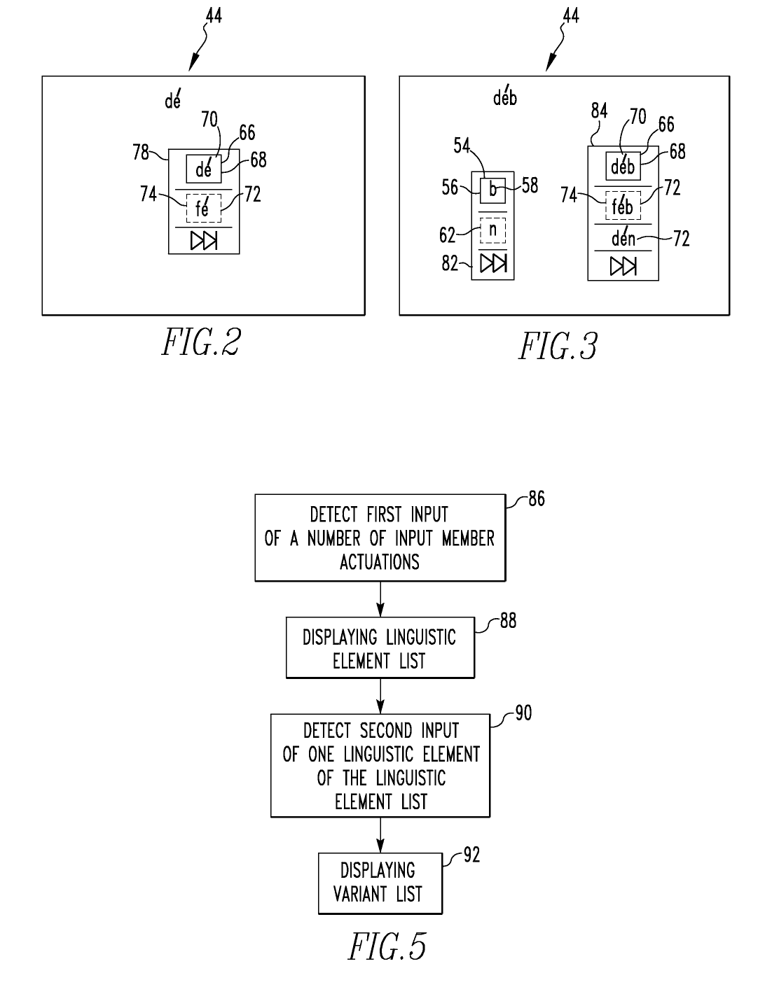

An improved handheld electronic device 2 is indicated generally in FIG. 1 and is depicted schematically in FIG. 4. The exemplary handheld electronic device 2 includes a housing 4 upon which is disposed a processor unit that includes an input apparatus 6, an output apparatus 8, a processor 10, a memory 12, and at least a first routine. The processor 10 may be, for instance, and without limitation, a microprocessor (μP) and is responsive to inputs from the input apparatus 6 and provides output signals to the output apparatus 8. The processor 10 also interfaces with the memory 12. The processor 10 and the memory 12 together form a processor apparatus. Examples of handheld electronic devices are included in U.S. Pat. Nos. 6,452,588 and 6,489,950, which are incorporated by reference herein.

As can be understood from FIG. 1, the input apparatus 6 includes a keypad 14 and a thumbwheel 16. As will be described in greater detail below, the keypad 14 is in the exemplary form of a reduced QWERTY keypad including a plurality of keys 18 that serve as input members. It is noted, however, that the keypad 14 may be of other configurations, such as an AZERTY keypad, a QWERTZ keypad, or other keypad arrangement, whether presently known or unknown, and either reduced or not reduced. A full sized keypad could be used with the disclosed and claimed concepts as well.

The keys 18 are located on a front face 20 of the housing 4, and the thumbwheel 16 is located at a side 22 of the housing 4. In addition to the keys 18, the thumbwheel 16 can serve as another input apparatus since the thumbwheel 16 is capable of being rotated, as indicated by arrow 24, and depressed generally toward the housing 4, as indicated by arrow 26. Rotation of the thumbwheel 16 provides navigational or selection inputs to the processor 10, while depression of the thumbwheel 16 provides another selection input to the processor 10.

As can further be seen in FIG. 1, many of the keys 18 include a one or more linguistic elements 36 disposed thereon. In the exemplary depiction of the keypad 14, many of the keys 18 include two linguistic elements 36, such as including a first linguistic element 38 and a second linguistic element 40 assigned thereto. Accordingly, when a key 18 having a first and a second linguistic element 38, 40 is depressed or actuated the input to the processor 10 from that particular key 18 can either be the first or second linguistic element 38, 40.

To illustrate, one of the keys 18 of the keypad 14 includes as the linguistic elements 36 thereof the letters “E” and “R”. If the key 18 on which the “E” and “R” are disposed is actuated, then the output of the key 18 can either be the letter “E” or the letter “R”. It can also be seen that the arrangement of the linguistic elements 36 on the keys 18 of the keypad 14 in FIG. 1 is generally of a QWERTY arrangement, albeit with many of the keys 18 including two linguistic elements 36.

Furthermore, numerals or punctuations may also be assigned to one or more keys 18 on the keypad 14. For example, the key 18 on which the letters “E” and “R” are disposed also includes the numeral “1”. In the particular embodiment of the keypad 18 that is depicted in FIG. 1, all of the numerals are entered into the handheld electronic device 2 by actuating the <SHIFT> key 42 immediately prior to actuating the key 18 on which the desired numeral is disposed. It should also be noted, however, that in other embodiments of the keypad 18 and/or when particular applications are being executed the actuation of the <SHIFT> key 42 prior to depressing the numeral key might not be necessary.

Moreover, one or more diacritical letters or diacritical versions may be associated with the key 18 on which, for example, the letters “E” and “R” are disposed, whether or not that key 18 displays the diacritical letters or diacritical versions of the linguistic elements 36. The output apparatus 8 includes a display 44 upon which can be provided an output 46. An exemplary output 46 is depicted on the display 44 in FIG. 1. The output 46 includes a text component 48, a first linguistic element list 50 and a first variant list 52. As can be seen from FIG. 1, the first linguistic element list 50 and the first variant list 52 extend substantially vertically across the display 44. This, however, is not meant to be limiting since the first linguistic element list 50 and the first variant list 52 can also extend across the display 44 substantially horizontally or be arranged in any other fashion. Preferably, the first linguistic element list 50 and the first variant list 52 are located generally in the vicinity of the text component 48.

The first linguistic element list 50 includes possible linguistic element selections determined, at least in part, by analyzing the input from actuation of a key 18 and the first variant list 52 include possible variant selections determined by analyzing the input from actuation of the key 18. The first linguistic element list 50 may include a plurality of linguistic elements displayed in an order of frequently used letters to seldomly used letters. In other words, the first linguistic element list 50 may display a plurality of linguistic elements in order of decreasing frequency of use of the linguistic elements. The first linguistic element list 50 includes a selection box 54 that appears in a default position 56 in FIG. 1. Initially, the default position 56 of the selection box 54 surrounds and/or highlights a preferred output or frequently used output 58 while the remainder of the first linguistic element list 50 displays various alternative outputs 60. The preferred output 58 is proposed by the processor 10 executing a routine as being the most likely interpretation of the ambiguous input provided by the user by actuating the key 18. The selection box 54 is capable of being moved (i.e. shifted) from the default position 56 to a number of other positions 62 by rotating the thumbwheel 16. By moving the selection box 54 to surround and/or highlight the various alternative outputs 60, the user is able to select any one of the various alternative outputs 60 for possible output on the output apparatus 8. The display 44 also includes a cursor 64 that depicts generally where the next output will be displayed.

As can be seen from FIG. 1, the first variant list 52 may display, for example, a plurality of prefixes in an order of frequently used variants to seldomly used variants. In other words, the first variant list 52 may display a plurality of prefixes in order of decreasing frequency of use of the variants. The first variant list 52 also includes a selection box 66 that initially appears in a default position 68. Initially, the default position 68 of the selection box 66 surrounds and/or highlights a preferred output or frequently used output 70 while the remainder of the first variant list 52 displays various alternative outputs 72. The preferred output 70 is proposed by a processor 10 executing a routine as being the most likely interpretation of the ambiguous input provided by the user by actuating a number of the keys 18. The selection box 66 is capable of moving (i.e. shifting) from the default position 68 to a number of other positions 74 by rotating the thumbwheel 16. By moving the selection box 66 to surround and/or highlight the various alternative outputs 72, the user is able to select any one of the various alternative outputs 72 for possible output on the output apparatus 8.

To illustrate, if a user actuates a key 18 on which the letters “E” and “R” are disposed after a key 18 has been actuated on which the letters “D” and F” are disposed, the handheld electronic device 2 will detect the actuation of the key 18 and the processor 10 will display on the output apparatus 8 the first linguistic element list 50. In this particular example, the handheld electronic device 2 will display within the first linguistic element list 50 the non-diacritical letters “e”, “r” and the diacritical letters “é” and “è” associated with this key 18. The first linguistic element list 50 typically displays the letters in an order of frequently used letters to seldomly used letters. In other words, the first linguistic element list 50 may display a plurality of linguistic elements, i.e., letters, in order of decreasing frequency of use of the linguistic elements. Alternatively, the first linguistic element list 50 may display letters based on linguistic patterns by analyzing the preceding linguistic element inputs. Assuming that the handheld electronic device 2 prefers the letter “e” as the frequently used output 58, the selection box 54 will initially surround or highlight the letter “e” while the letters “r”, “é” and “è”, the alternative outputs 60, will be displayed outside of the selection box 54. The letter “e”, which is the frequently used output 58, is automatically output at the original position of the cursor 64. The user can then continue to input additional linguistic elements into the handheld electronic device 2 by actuating the input members on the handheld electronic device 2 which would generate additional linguistic element lists and additional variant lists.

Alternatively, if the user would like to select one of the other letters “r”, “é” or “è” as opposed to the preferred letter “e”, then the user would move the selection box 54 to surround or highlight one of the other letters, such as “é” by rotating the thumbwheel 16. Once the letter “é” has been surrounded or highlighted by the selection box 54, the highlighted letter “é” may be selected by the user by actuating another key 18 on the keypad 14, depressing the thumbwheel 16, actuating the space bar, actuating the enter key or continuing to type. The letter “é” is then displayed on the output apparatus 8 in place of the letter “e”. At this point, the handheld electronic device 2 would generate a second variant list 78 as shown in FIG. 2 that displays only variants having the input of the selected diacritical letter “é” which is described in further detail below.

Prior to, concurrently with, or subsequent to the display of the first linguistic element list 50, once the user actuates the key 18 on which the letters “E” and “R” are disposed, the handheld electronic device 2 will detect the actuation of the key 18 and the processor 10 will display on the output apparatus 8 the first variant list 52 in addition to the first linguistic element list 50. In this particular example, the handheld electronic device 2 will display within the first variant list 52 possible variant selections by analyzing the inputs to the handheld electronic device 2 with reference to one or more vocabulary modules 80. The vocabulary modules 80 typically contain a plurality of variants such as words and/or portions of words with information about each variant such as the frequency of occurrence of each variant with respect to other variants of the vocabulary module. Additionally, the vocabulary modules 80 may include variants in a plurality of languages and may generate or provide variants based on linguistic patterns.

Based on the inputs made to the handheld electronic device 2, the first variant list 52 will display a plurality of variants in an order of frequently used variants to seldomly used variants. In other words, the first variant list 52 may display a plurality of variants in order of decreasing frequency of use of the variants. Assuming that the handheld electronic device 2 prefers the variant “de” as the frequently used output 70, the selection box 66 will initially surround or highlight the variant “de” while the variants “dr” and “fe”, the alternative outputs 72, will be displayed outside of the selection box 66. The variants, “de”, “dr” and “fe” are, for example, French word segments or portions of French words. If desired, the variant “de”, which is the preferred output 70, may be selected by the user by actuating another key 18 on the keypad 14 or depressing the thumbwheel 16 when the cursor 64 is highlighting the selection box 66; however, such a selection is unnecessary in this particular example since the output apparatus 8 already displays the variant “de”. Additionally, if desired, the user can continue to input additional linguistic elements into the handheld electronic device 2 by actuating the input members on the handheld electronic device 2 which would generate additional linguistic element lists and additional variant lists.

Alternatively, if the user would rather select the variant “dr” as opposed to the preferred variant “de”, then the user could move the selection box 66 to surround or highlight the variant “dr” by rotating the thumbwheel 16. Once the variant “dr” has been surrounded or highlighted by the selection box 66, the variant may be selected by the user by actuating another key 18 on the keypad 14 or depressing the thumbwheel 16 when the cursor 64 is highlighting the selection box 66 and the variant “dr” is then displayed on the output apparatus 8. Additionally, if desired, the user can continue to input additional linguistic elements into the handheld electronic device 2 by actuating the input members on the handheld electronic device 2 which would generate additional linguistic element lists and additional variant lists.

Alternatively, if the user selected the diacritical letter “é” from the first linguistic element list 50 as described above, the second variant list 78 of FIG. 2 appears replacing the first variant list 52 from the display 44 of the handheld electronic device 2 with the diacritical letter “é” replacing the non-diacritical letter “e” from the display 44. In this particular example, the handheld electronic device 2 will display within the second variant list 78 possible variant selections by analyzing the diacritical letter inputted from the first linguistic element list 50. The diacritical letter information could be obtained from the vocabulary modules 80 which assist in generating the first variant list 52, the second variant list 78 and other variant lists. In other words, the second variant list 78 may only display those possible variants having a diacritical letter in the position defined by the inputs entered by the user. Based on the diacritical input made to the handheld electronic device 2, the second variant list 78 will display a plurality of variants in an order of frequently used variants to seldomly used variants with the diacritical letter in the position selected by the user from the first linguistic element list 50. In other words, the second variant list 78 may display variants in order of decreasing frequency of use of the variants. Assuming that the handheld electronic device 2 prefers the variant “dé” as the frequently used output 70, the selection box 66 will initially surround or highlight the variant “dé” while the variant “fé”, the alternative output 72, will be displayed outside of the selection box 66. The variants “dé” and “fé” are French word segments or portions of French words. If desired, the variant “dé”, which is the preferred output 70, may be selected by the user by actuating another key 18 on the keypad 14 or depressing the thumbwheel 16 when the cursor 64 is highlighting the selection box 66; however, such a selection is unnecessary in this particular example since the output apparatus 8 already displays the variant “dé”. Additionally, if desired, the user can continue to input additional linguistic elements into the handheld electronic device 2 by actuating the input members on the handheld electronic device 2 which would generate additional linguistic element lists and additional variant lists.

Alternatively, if desired, the user could select the alternative variant from the second variant list 78 in accordance with the method described above for the first variant list 52. For the purpose of simplifying the specification, that method will not be repeated herein, it being noted that the method of selecting an alternative variant from the second variant list 78 is generally the same as the method of selecting alternative variants from the first variant list 52 and the description of that method is hereby incorporated by reference with respect to the second variant list 78.

Alternatively, if the user does not wish to select a variant from the second variant list 78, the user may opt to actuate, for example, another key 18 on the keypad 14 such as the key 18 on which the letters “B” and “N” are disposed. In response thereto, the handheld electronic device 2 will detect the actuation of the key 18 and optionally display on the output apparatus 8 a second linguistic element list 82 and a third variant list 84. The second linguistic element list 82 replaces the first linguistic element list 50 and the third variant list 84 replaces the second variant list 78 for the display 44 of the handheld electronic device 2. In this particular example, the handheld electronic device 2 will display within the second linguistic element list 82 the non-diacritical letters “b” and “n” associated with this key 18. Since there are no diacritical letters associated with this key 18 in the French language, for example, no diacritical letters appear in the second linguistic element list 78. The second linguistic element list 82 typically displays the letters in an order of frequently used letters to seldomly used letters; however, the second linguistic element list 82 may display letters based on linguistic patterns by analyzing the preceding linguistic element input into the handheld electronic device 2. Here, the processor 10 analyzes the previously inputted linguistic element with the vocabulary modules 80 and determines that it is not as likely to have the letter “n” following the preceding input of the letter “é” so the processor opts to display the letter “b” above the letter “n” in the analysis of this linguistic pattern. The selection box 54 will initially surround or highlight the letter “b” while the letter “n”, the alternative output 60, will be displayed outside of the selection box 54. The letter “b”, which is the frequently used output 58 based on linguistic pattern analysis, is automatically output at the original position of the cursor 64. The user can then continue to input additional linguistic elements into the handheld electronic device 2 by actuating the input members on the handheld electronic device 2 which would generate additional linguistic element lists and additional variant lists.

Alternatively, after the letter “é” was input and the third variant list 84 of FIG. 3 appears, the handheld electronic device 2 will display within the third variant list 84 possible variant selections by analyzing the diacritical letter inputted from the first linguistic element list 50 and the letter inputted from the actuation of one of the input members. The diacritical letter and non-diacritical letter information could be obtained from the vocabulary modules 80 which assist in generating the first variant list 52, the second variant list 78, the third variant list 84 and other variant lists. In other words, the third variant list 84 may only display those possible variants having a diacritical letter in the position defined by the inputs entered by the user. Based on the diacritical input made to the handheld electronic device 2, the third variant list 84 will display a plurality of variants in an order of frequently used variants to seldomly used variants with the diacritical letter in the position selected by the user from the first linguistic element list 50. Assuming that the handheld electronic device 2 prefers the variant “déb” as the frequently used output 70, the selection box 66 will initially surround or highlight the variant “déb” while the variants “féb” and “dén”, the alternative outputs 72, will be displayed outside of the selection box 66. If desired, the user could select any one of these variants in accordance with the method previously described for the first variant list 52. For the purpose of simplifying the specification, that method will not be repeated herein, it being noted that the method of selecting variants from the third variant list 84 is generally the same as the method of selecting variants from the first variant list 52 and the description of that method is hereby incorporated by reference with respect to the third variant list 84. Additionally, if desired, the user can continue to input additional linguistic elements into the handheld electronic device 2 by actuating the input members on the handheld electronic device 2 which would generate additional linguistic element lists and additional variant lists.

While the above example has focused on the French language, it should be readily apparent that other languages could benefit from the disclosed and claimed concepts and that the scope of the appended claims should not be construed as limited to the French language. For example, it is noted that the disclosed and claimed concept can also be used with other languages that may have diacritical letters including, but not limited to, the Romanic languages such as German, Spanish, Italian, and Portuguese as well as the Cyrillic languages such as Greek and Russian.

There are, therefore, certain circumstances in various languages when the user would prefer to display a diacritical letter as opposed to a non-diacritical letter on the output apparatus 8. The commonly used French diacritical letters are “à”, “é”, “è”, [symbol] , “ù” and other diacritical letters. The proper use of accentuation is seen as an important grammar and language issue in the French culture and a diacritical selection system would be welcomed.

With regard to the German language, the commonly used German diacritical letters are “ä”, “ö”, “ü” and other diacritical letters. These letters are commonly referred to as the “umlaute” letters. While it is possible to respectively transcribe these letters as ae, oe and ue, it is more aesthetically pleasing to the user of the handheld electronic device 2 to see the use of the “umlaute” letters. Also, the letter “β” is a ligature, which means two letters, e.g., “ss”, written as a unit. The letter “β” is also called es-zett or scharffes s. It is possible to write the letter “β” as “ss”, but this form is not so aesthetically pleasing to the user of the handheld electronic device 2. The proper use of accentuation is seen as an important grammar and language issue in the German culture and a diacritical selection system would be welcomed.

The commonly used diacritical letters in the Italian language are “à”, “è”, “ì”, “ò” and “ù”. The diacritical letters are typically placed on the last letter of a word. Diacritical letters in Italian are considered separate individual letters so the difference between the non-diacritical letter. “a” and the diacritical letter “à” is as significant as the difference between the letters “b” and “c”. Not using the proper accent at the end of an Italian word is considered a serious grammatical error. The proper use of accentuation is seen as an important grammar and language issue in the Italian culture and a diacritical selection system would be welcomed.

Turning to FIG. 4, the memory 12 of the handheld electronic device 2 is depicted schematically. The memory 12 can be any of a variety of types of internal and/or external storage media such as, without limitation, RAM, ROM, EPROM(s), EEPROM(s), and the like that provide a storage register for data storage such as in the fashion of an internal storage area of a computer, and can be volatile memory or nonvolatile memory. As can be seen from FIG. 4, the memory 12 is in electronic communication with the processor 10. The memory 12 additionally includes a number of routines 76 for the processing of data. The routines 76 can be in any of a variety of forms such as, without limitation, software, firmware, and the like. As will be explained in greater detail below, the routines 76 include a routine that can be executed to perform a method in accordance with the disclosed and claimed concept as well as other routines 76 that are utilized by the handheld electronic device 2. Additionally, the memory 12 can also store a variety of databases and information such as, without limitation, a language database and vocabulary modules 80.

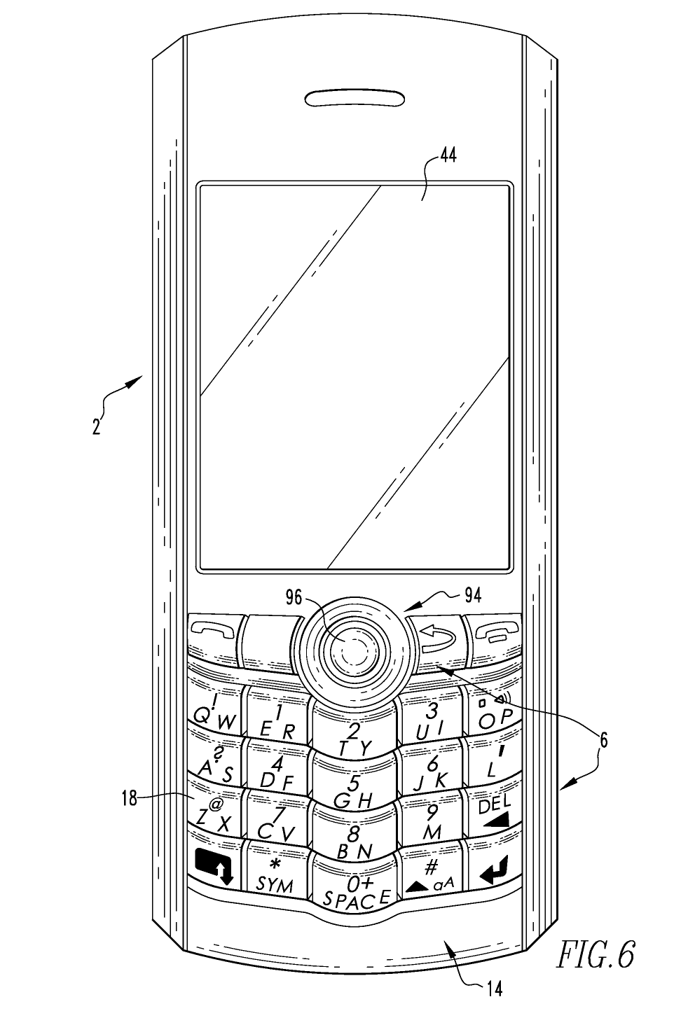

According to an aspect of the present concept, the handheld electronic device 2 includes a routine 76, stored in memory 12 and executable by the processor 10, for selecting diacritical accents and disambiguating text. This routine 76 may be used, for example, to select the diacritical letter “é” over the non-diacritical letter “e”. A flowchart depicting one embodiment of the routine 76 is depicted in FIG. 5.

As can be understood from FIG. 5, the routine 76 begins at step 86, where the handheld electronic device 2 detects as a first input a number of input member actuations comprising an actuation of one of the input members having assigned thereto both a non-diacritical version and a diacritical version.

Once the first input has been detected by the handheld electronic device 2, the handheld electronic device 2 responds, as at 88, by displaying the first linguistic element list 50 for selection by a user comprising the non-diacritical version and at least one diacritical version.

After the handheld electronic device 2 has displayed, at 88, the first linguistic element list 50, the handheld electronic device 2 then detects, as at 90, a second input of a selection by the user of one linguistic element of the first linguistic element list 50.

Once the second input has been detected by the handheld electronic device 2, the handheld electronic device 2 displays, as at 92, a second variant list 78 for selection by the user and comprising a number of variants, at least some of the variants each comprising the selected linguistic element of the second input.

Optionally, once the first input has been detected by the handheld electronic device 2, the handheld electronic device 2 may respond by displaying a first variant list for selection by the user determined by analyzing the first input.

Turning to FIG. 6, an alternate handheld electronic device 2 is displayed, which is but another example of a type of a handheld electronic device to which aspects of the disclosed and claimed concepts can be applied. Elements that are presented in FIG. 6 which are similar to the elements found in FIG. 1 are labeled with the same element number in FIG. 6. The exemplary handheld electronic device 2 includes an input apparatus 6 in the form of a keypad 14 and a navigational tool 94 that is used to control the functions of the handheld electronic device 2 and to generate text and other inputs. The keypad 14 constitutes a reduced QWERTY keypad in which most of the keys 18 are used to input two letters of the alphabet. It is noted, however, that the keypad 14 may be of other configurations, such as an AZERTY keypad, a QWERTZ keypad, or other keypad arrangement, whether presently known or unknown, and either reduced or not reduced. Thus, initially the input generated by depressing one of these keys is ambiguous in that it is undetermined as to which letter was intended. Various schemes have been devised for disambiguating the inputs generated by these keys 18 assigned multiple letters for input. Continuing with FIG. 6, the handheld electronic device 2 also includes the navigational tool 94. In this particular embodiment, the navigational tool 94 is a trackball 96 that can be rotated thereby allowing for the navigation of a cursor which is displayed on a display 44 in various directions including up, down, left, right, and any combination thereof. Moreover, the trackball 96 can also be depressed. When the trackball 96 is depressed, a selection is made based upon the current location of the cursor. For example, if the cursor is located over a given program icon, that program will be launched when the trackball 96 is depressed. The input provided through the keypad 14 and trackball 96 is displayed on the display 44.

It should be noted, however, that despite FIG. 6 depicting the navigational tool 94 as being disposed on the front face of the handheld electronic device 2, the navigational tool 94 can also be disposed on a side of the handheld electronic device 2 in the form of the thumbwheel 16 as shown in FIG. 1. The thumbwheel 16 of FIG. 1, which is capable of being rotated and depressed, may be disposed on the side of the handheld electronic device 2 of FIG. 1 in lieu of the trackball 96. Rotation of the thumbwheel 16 can provide a navigation input, while depression of the thumbwheel 16 can provide a selection input. Accordingly, rotation of the thumbwheel 16 can navigate the cursor over a particular program icon, while depression of the thumbwheel 16 with the cursor located over a given program icon can launch the program.

While specific embodiments of the disclosed and claimed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed and claimed concept which is to be given the full breadth of the claims appended and any and all equivalents thereof.

1. A method of enabling input on a handheld electronic device, the handheld electronic device including an input apparatus having a number of input members with at least some of the input members having a number of linguistic elements assigned thereto with at least a portion of the number of linguistic elements including a non-diacritical version assigned thereto and a diacritical version assigned thereto, the method comprising:
detecting as a first input a number of input member actuations comprising an actuation of one of the input members having assigned thereto both the non-diacritical version and the diacritical version;
responsive to said detecting of the first input, displaying a linguistic element list for selection by a user comprising the non-diacritical version and at least one diacritical version;
detecting as a second input a selection by the user of one linguistic element of the linguistic element list; and
responsive to said detecting of the second input, displaying a variant list for selection by the user and comprising a number of variants, at least some of the variants each comprising the selected linguistic element of the second input.

2. The method of claim 1, further comprising responsive to said detecting of the first input, displaying a variant list for selection by the user determined by analyzing the first input.

3. The method of claim 1, wherein the variants in the variant list are displayed in order of decreasing frequency of use.

4. The method of claim 1, wherein the linguistic elements of the linguistic element list are displayed in order of decreasing frequency of use of the linguistic elements.

5. The method of claim 1, further comprising performing an analysis of one or more vocabulary modules and outputting the linguistic elements of the linguistic element list in an order determined at least in part by the analysis.

6. The method of claim 5, wherein the one or more vocabulary modules contain a plurality of words with information about each word, the information including the frequency of occurrence of each word with respect to other words of the vocabulary module.

7. The method of claim 5, wherein the one or more vocabulary modules include words in a plurality of languages.

8. The method of claim 5, wherein the one or more vocabulary modules comprise linguistic patterns.

9. The method of claim 1, wherein the variant list only displays variants having the selected linguistic element of the second input.

10. A handheld electronic device comprising:
an input apparatus having a number of input members with at least some of the input members having a number of linguistic elements assigned thereto with at least a portion of the number of linguistic elements including a non-diacritical version assigned thereto and a diacritical version assigned thereto;
an output apparatus having a display;
a processor apparatus comprising a processor and a memory in electronic communication with the processor, the memory storing one or more routines which, when executed by the processor, cause the handheld electronic device to perform operations comprising:
detecting as a first input a number of input member actuations comprising an actuation of one of the input members having assigned thereto both the non-diacritical version and the diacritical version;
responsive to said detecting of the first input, displaying a linguistic element list for selection by a user comprising the non-diacritical version and at least one diacritical version;
detecting as a second input a selection by the user of one linguistic element of the linguistic element list; and
responsive to said detecting of the second input, displaying a variant list for selection by the user and comprising a number of variants, at least some of the variants each comprising the selected linguistic element of the second input.

11. The handheld electronic device of claim 10, further comprising responsive to said detecting of the first input, displaying a variant list for selection by the user determined by analyzing the first input.

12. The handheld electronic device of claim 10, wherein the variants in the variant list are displayed in order of decreasing frequency of use.

13. The handheld electronic device of claim 10, wherein the linguistic elements of the linguistic element list are displayed in order of decreasing frequency of use of the linguistic elements.

14. The handheld electronic device of claim 10, further comprising performing an analysis of one or more vocabulary modules and outputting the linguistic elements of the linguistic element list in an order determined at least in part by the analysis.

15. The handheld electronic device of claim 14, wherein the one or more vocabulary modules contain a plurality of words with information about each word, the information including the frequency of occurrence of each word with respect to other words of the vocabulary module.

16. The handheld electronic device of claim 14, wherein the one or more vocabulary modules include words in a plurality of languages.

17. The handheld electronic device of claim 14, wherein the one or more vocabulary modules comprise linguistic patterns.

18. The handheld electronic device of claim 10, wherein the variant list only displays variants having the selected linguistic element of the second input.
